(19) United States
(12) Patent Application Publication
(10) Pub. No.: US 2026/0037437 A1
(43) Pub. Date: Feb. 5, 2026

(54) ENHANCED GARBAGE COLLECTION AT A MEMORY SYSTEM

(71) Applicant: Micron Technology, Inc., Boise, ID (US)

(72) Inventors: Chaohui Liu, Shanghai (CN); Ping He, Shanghai (CN); Wenjun Wu, Shanghai (CN)

(21) Appl. No.: 19/281,222

(22) Filed: Jul. 25, 2025

Related U.S. Application Data
(60) Provisional application No. 63/678,469, filed on Aug. 1, 2024.

(51) Int. Cl. G06F 12/02

(52) U.S. Cl. CPC G06F 12/0253

(57) ABSTRACT

Methods, systems, and devices for enhanced garbage collection at a memory system are described. The method by the memory system may include receiving signaling indicating a state of one or more logical memory addresses and determining whether a state of a first logical memory address of the one or more logical memory addresses includes the valid state or the invalid state in response to the signaling. Further, the method by the memory system may include adjusting (e.g., incrementing) a counter allocated to a memory region corresponding to the first logical memory address in response to determining that the state of the first logical memory address includes the valid state and performing a garbage collection operation in accordance with a value of the counter.

### CROSS REFERENCE

The present Application for Patent claims priority to U.S. Patent Application No. 63/678,469 by Liu et al., entitled “ENHANCED GARBAGE COLLECTION AT A MEMORY SYSTEM,” filed Aug. 1, 2024, which is assigned to the assignee hereof, and which is expressly incorporated by reference in its entirety herein.

### TECHNICAL FIELD

The following relates to one or more systems for memory, including enhanced garbage collection at a memory system.

### BACKGROUND

Memory devices are widely used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored. To access the stored information, the memory device may read (e.g., sense, detect, retrieve, determine) states from the memory cells. To store information, the memory device may write (e.g., program, set, assign) states to the memory cells.

Various types of memory devices exist, including magnetic hard disks, random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), self-selecting memory, chalcogenide memory technologies, not-or (NOR) and not-and (NAND) memory devices, and others. Memory cells may be described in terms of volatile configurations or non-volatile configurations. Memory cells configured in a non-volatile configuration may maintain stored logic states for extended periods of time even in the absence of an external power source. Memory cells configured in a volatile configuration may lose stored states when disconnected from an external power source.

### BRIEF DESCRIPTION OF THE DRAWINGS

FIG. 1 shows an example of a system that supports enhanced garbage collection at a memory system in accordance with examples as disclosed herein.

FIG. 2 shows an example of a system that supports enhanced garbage collection at a memory system in accordance with examples as disclosed herein.

FIG. 3 shows an example of a flow diagram that supports enhanced garbage collection at a memory system in accordance with examples as disclosed herein.

FIG. 4 shows a block diagram of a memory system that supports enhanced garbage collection at a memory system in accordance with examples as disclosed herein.

FIG. 5 shows a flowchart illustrating a method or methods that support enhanced garbage collection at a memory system in accordance with examples as disclosed herein.

### DETAILED DESCRIPTION

In some examples, a host system may invalidate one or more logical memory addresses (e.g., logical block addresses (LBAs)) based on one or more conditions. To keep track of which logical memory addresses are invalid, the host system may store a segment information table (SIT). The SIT may be, for example, a bitmap, where each bit in the bitmap indicates whether a corresponding logical memory address is valid or invalid. If the host system updates a logical memory address from valid to invalid, the host system may update the SIT to indicate that the logical memory address is invalid.

Further, some duration after updating the SIT, the host system may transmit signaling (e.g., an unmap command), to a memory system, indicating that the logical memory address is invalid. However, prior to receiving this signaling, the memory system may have no information that the logical memory address is invalid. Thus, prior to receiving the signaling, the memory system may perform operations (e.g., garbage collection) under the condition that the logical memory address is valid which may decrease the efficiency and reliability of memory system operations.

As described herein, the host system may provide SIT information to the memory system such that the memory system may perform more reliable operations. In some examples, upon updating the SIT, the host system may send signaling to the memory system indicating the SIT information (e.g., the SIT or the update to the SIT). Upon receiving the signaling and while in a mode, such as a sleep mode, the memory system may build backup valid page counts (VPCs) (e.g., different than VPCs stored at the memory system) for memory regions (e.g., blocks of memory cells) of the memory system using the SIT information. Both a backup VPC and a VPC may indicate a quantity of valid pages for a memory region. However, the memory system may build the backup VPCs based on the SIT information, whereas the VPCs may be built using other information.

To build the backup VPC, the memory system may identify a logical memory address of a memory region corresponding to the backup VPC and, adjust (e.g., increment, increase, change, modify) the backup VPC (e.g., by a value of one) if the SIT information indicates that the logical memory address is valid. The memory system may repeat this process for each logical memory address of the memory region. Upon building the backup VPCs and the VPCs, the memory system may utilize one or both of the backup VPCs or the VPCs to perform operations (e.g., garbage collection). For example, the memory system may select a memory region whose corresponding backup VPC is lower than other backup VPCs of other memory regions as a source block for garbage collection. Additionally, or alternatively, the memory system may prioritize garbage collection on a memory region whose value is the same in the backup VPC and the other VPC. Using the methods as described herein may allow the memory system to gain knowledge of invalid logical memory addresses prior to the unmap command from the host system, which may increase the reliability and efficiency of memory system operations.

In addition to applicability in memory systems as described herein, techniques for enhanced garbage collection at a memory system may be generally implemented to improve the performance of various electronic devices and systems (including artificial intelligence (AI) applications, augmented reality (AR) applications, virtual reality (VR) applications, and gaming). Some electronic device applications, including high-performance applications such as AI, AR, VR, and gaming, may be associated with relatively high processing requirements to satisfy user expectations. As such, increasing processing capabilities of the electronic devices by decreasing response times, improving power consumption, reducing complexity, increasing data throughput or access speeds, decreasing communication times, or increasing memory capacity or density, among other performance indicators, may improve user experience or appeal. Implementing the techniques described herein may improve the performance of electronic devices by decreasing processing or latency times, improving response times, or otherwise improve user experience, among other benefits.

Features of the disclosure are illustrated and described in the context of systems, devices, and circuits. Features of the disclosure are further illustrated and described in the context of a flow diagram and flowcharts.

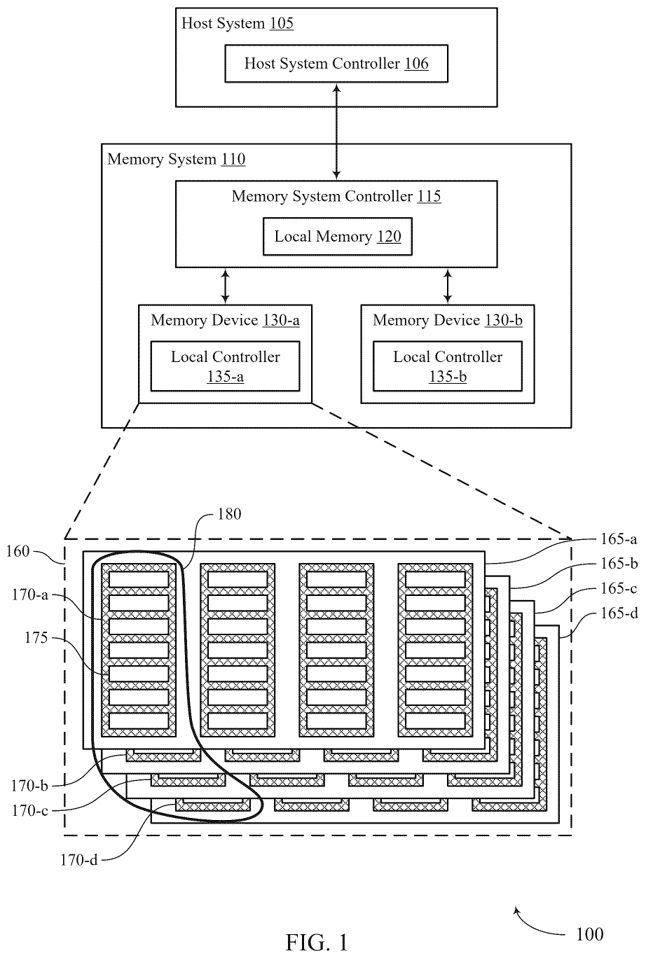

FIG. 1 shows an example of a system 100 that supports enhanced garbage collection at a memory system in accordance with examples as disclosed herein. The system 100 includes a host system 105 coupled with a memory system 110. The system 100 may be included in a computing device such as a desktop computer, a laptop computer, a network server, a mobile device, a vehicle, an Internet of Things (IoT) enabled device, an embedded computer (e.g., one included in a vehicle, industrial equipment, or a networked commercial device), or any other computing device that includes memory and a processing device.

A memory system 110 may be or include any device or collection of devices, where the device or collection of devices includes at least one memory array. For example, a memory system 110 may be or include a Universal Flash Storage (UFS) device, an embedded Multi-Media Controller (eMMC) device, a flash device, a universal serial bus (USB) flash device, a secure digital (SD) card, a solid-state drive (SSD), a hard disk drive (HDD), a dual in-line memory module (DIMM), a small outline DIMM (SO-DIMM), or a non-volatile DIMM (NVDIMM), among other devices.

The system 100 may include a host system 105, which may be coupled with the memory system 110. In some examples, this coupling may include an interface with a host system controller 106, which may be an example of a controller or control component configured to cause the host system 105 to perform various operations in accordance with examples as described herein. The host system 105 may include one or more devices and, in some cases, may include a processor chipset and a software stack executed by the processor chipset. For example, the host system 105 may include an application configured for communicating with the memory system 110 or a device therein. The processor chipset may include one or more cores, one or more caches (e.g., memory local to or included in the host system 105), a memory controller (e.g., NVDIMM controller), and a storage protocol controller (e.g., peripheral component interconnect express (PCIe) controller, serial advanced technology attachment (SATA) controller). The host system 105 may use the memory system 110, for example, to write data to the memory system 110 and read data from the memory system 110. Although one memory system 110 is shown in FIG. 1, the host system 105 may be coupled with any quantity of memory systems 110.

The host system 105 may be coupled with the memory system 110 via at least one physical host interface. The host system 105 and the memory system 110 may, in some cases, be configured to communicate via a physical host interface using an associated protocol (e.g., to exchange or otherwise communicate control, address, data, and other signals between the memory system 110 and the host system 105). Examples of a physical host interface may include, but are not limited to, a SATA interface, a UFS interface, an eMMC interface, a PCIe interface, a USB interface, a Fiber Channel interface, a Small Computer System Interface (SCSI), a Serial Attached SCSI (SAS), a Double Data Rate (DDR) interface, a DIMM interface (e.g., DIMM socket interface that supports DDR), an Open NAND Flash Interface (ONFI), and a Low Power Double Data Rate (LPDDR) interface. In some examples, one or more such interfaces may be included in or otherwise supported between a host system controller 106 of the host system 105 and a memory system controller 115 of the memory system 110. In some examples, the host system 105 may be coupled with the memory system 110 (e.g., the host system controller 106 may be coupled with the memory system controller 115) via a respective physical host interface for each memory device 130 included in the memory system 110, or via a respective physical host interface for each type of memory device 130 included in the memory system 110.

The memory system 110 may include a memory system controller 115 and one or more memory devices 130. A memory device 130 may include one or more memory arrays of any type of memory cells (e.g., non-volatile memory cells, volatile memory cells, or any combination thereof). Although two memory devices 130-a and 130-b are shown in the example of FIG. 1, the memory system 110 may include any quantity of memory devices 130. Further, if the memory system 110 includes more than one memory device 130, different memory devices 130 within the memory system 110 may include the same or different types of memory cells.

The memory system controller 115 may be coupled with and communicate with the host system 105 (e.g., via the physical host interface) and may be an example of a controller or control component configured to cause the memory system 110 to perform various operations in accordance with examples as described herein. The memory system controller 115 may also be coupled with and communicate with memory devices 130 to perform operations such as reading data, writing data, erasing data, or refreshing data at a memory device 130—among other such operations-which may generically be referred to as access operations. In some cases, the memory system controller 115 may receive commands from the host system 105 and communicate with one or more memory devices 130 to execute such commands (e.g., at memory arrays within the one or more memory devices 130). For example, the memory system controller 115 may receive commands or operations from the host system 105 and may convert the commands or operations into instructions or appropriate commands to achieve the desired access of the memory devices 130. In some cases, the memory system controller 115 may exchange data with the host system 105 and with one or more memory devices 130 (e.g., in response to or otherwise in association with commands from the host system 105). For example, the memory system controller 115 may convert responses (e.g., data packets or other signals) associated with the memory devices 130 into corresponding signals for the host system 105.

The memory system controller 115 may be configured for other operations associated with the memory devices 130. For example, the memory system controller 115 may execute or manage operations such as wear-leveling operations, garbage collection operations, error control operations such as error-detecting operations or error-correcting operations, encryption operations, caching operations, media management operations, background refresh, health monitoring, and address translations between logical addresses (e.g., LBAs) associated with commands from the host system 105 and physical addresses (e.g., physical block addresses) associated with memory cells within the memory devices 130.

The memory system controller 115 may include hardware such as one or more integrated circuits or discrete components, a buffer memory, or a combination thereof. The hardware may include circuitry with dedicated (e.g., hard-coded) logic to perform the operations ascribed herein to the memory system controller 115. The memory system controller 115 may be or include a microcontroller, special purpose logic circuitry (e.g., a field programmable gate array (FPGA), an application specific integrated circuit (ASIC), a digital signal processor (DSP)), or any other suitable processor or processing circuitry.

The memory system controller 115 may also include a local memory 120. In some cases, the local memory 120 may include read-only memory (ROM) or other memory that may store operating code (e.g., executable instructions) executable by the memory system controller 115 to perform functions ascribed herein to the memory system controller 115. In some cases, the local memory 120 may additionally, or alternatively, include static random access memory (SRAM) or other memory that may be used by the memory system controller 115 for internal storage or calculations, for example, related to the functions ascribed herein to the memory system controller 115. Additionally, or alternatively, the local memory 120 may serve as a cache for the memory system controller 115. For example, data may be stored in the local memory 120 if read from or written to a memory device 130, and the data may be available within the local memory 120 for subsequent retrieval for or manipulation (e.g., updating) by the host system 105 (e.g., with reduced latency relative to a memory device 130) in accordance with a cache policy.

Although the example of the memory system 110 in FIG. 1 has been illustrated as including the memory system controller 115, in some cases, a memory system 110 may not include a memory system controller 115. For example, the memory system 110 may additionally, or alternatively, rely on an external controller (e.g., implemented by the host system 105) or one or more local controllers 135, which may be internal to memory devices 130, respectively, to perform the functions ascribed herein to the memory system controller 115. In general, one or more functions ascribed herein to the memory system controller 115 may, in some cases, be performed instead by the host system 105, a local controller 135, or any combination thereof. In some cases, a memory device 130 that is managed at least in part by a memory system controller 115 may be referred to as a managed memory device. An example of a managed memory device is a managed NAND (MNAND) device.

A memory device 130 may include one or more arrays of non-volatile memory cells. For example, a memory device 130 may include NAND (e.g., NAND flash) memory, ROM, phase change memory (PCM), self-selecting memory, other chalcogenide-based memories, ferroelectric random access memory (FeRAM), magneto RAM (MRAM), NOR (e.g., NOR flash) memory, Spin Transfer Torque (STT)-MRAM, conductive bridging RAM (CBRAM), resistive random access memory (RRAM), oxide based RRAM (OxRAM), electrically erasable programmable ROM (EEPROM), or any combination thereof. Additionally, or alternatively, a memory device 130 may include one or more arrays of volatile memory cells. For example, a memory device 130 may include RAM memory cells, such as dynamic RAM (DRAM) memory cells and synchronous DRAM (SDRAM) memory cells.

In some examples, a memory device 130 may include (e.g., on the same die, within the same package) a local controller 135, which may execute operations on one or more memory cells of the respective memory device 130. A local controller 135 may operate in conjunction with a memory system controller 115 or may perform one or more functions ascribed herein to the memory system controller 115. For example, as illustrated in FIG. 1, a memory device 130-a may include a local controller 135-a and a memory device 130-b may include a local controller 135-b. A local controller 135 may be or include a microcontroller, special purpose logic circuitry (e.g., a field programmable gate array (FPGA), an application specific integrated circuit (ASIC), a digital signal processor (DSP)), or any other suitable processor or processing circuitry.

In some cases, a memory device 130 may be or include a NAND device (e.g., NAND flash device). A memory device 130 may be or include a die 160 (e.g., a memory die). For example, in some cases, a memory device 130 may be a package that includes one or more dies 160. A die 160 may, in some examples, be a piece of electronics-grade semiconductor cut from a wafer (e.g., a silicon die cut from a silicon wafer). Each die 160 may include one or more planes 165, and each plane 165 may include a respective set of blocks 170, where each block 170 may include a respective set of pages 175, and each page 175 may include a set of memory cells.

In some cases, a NAND memory device 130 may include memory cells configured to each store one bit of information, which may be referred to as single level cells (SLCs). Additionally, or alternatively, a NAND memory device 130 may include memory cells configured to each store multiple bits of information, which may be referred to as multi-level cells (MLCs) if configured to each store two bits of information, as tri-level cells (TLCs) if configured to each store three bits of information, as quad-level cells (QLCs) if configured to each store four bits of information, or more generically as multiple-level memory cells. Multiple-level memory cells may provide greater density of storage relative to SLC memory cells but may, in some cases, involve narrower read or write margins or greater complexities for supporting circuitry.

In some cases, planes 165 may refer to groups of blocks 170 and, in some cases, concurrent operations may be performed on different planes 165. For example, concurrent operations may be performed on memory cells within different blocks 170 so long as the different blocks 170 are in different planes 165. In some cases, an individual block 170 may be referred to as a physical block, and a virtual block 180 may refer to a group of blocks 170 within which concurrent operations may occur. For example, concurrent operations may be performed on blocks 170-a, 170-b, 170-c, and 170-d that are within planes 165-a, 165-b, 165-c, and 165-d, respectively, and blocks 170-a, 170-b, 170-c, and 170-d may be collectively referred to as a virtual block 180. In some cases, a virtual block may include blocks 170 from different memory devices 130 (e.g., including blocks in one or more planes of memory device 130-a and memory device 130-b). In some cases, the blocks 170 within a virtual block may have the same block address within their respective planes 165 (e.g., block 170-a may be “block 0” of plane 165-a, block 170-b may be “block 0” of plane 165-b, and so on). In some cases, performing concurrent operations in different planes 165 may be subject to one or more restrictions, such as concurrent operations being performed on memory cells within different pages 175 that have the same page address within their respective planes 165 (e.g., related to command decoding, page address decoding circuitry, or other circuitry being shared across planes 165).

In some cases, a block 170 may include memory cells organized into rows (pages 175) and columns (e.g., strings, not shown). For example, memory cells in the same page 175 may share (e.g., be coupled with) a common word line, and memory cells in the same string may share (e.g., be coupled with) a common digit line (which may alternatively be referred to as a bit line).

For some NAND architectures, memory cells may be read and programmed (e.g., written) at a first level of granularity (e.g., at a page level of granularity, or portion thereof) but may be erased at a second level of granularity (e.g., at a block level of granularity). That is, a page 175 may be the smallest unit of memory (e.g., set of memory cells) that may be independently programmed or read (e.g., programed or read concurrently as part of a single program or read operation), and a block 170 may be the smallest unit of memory (e.g., set of memory cells) that may be independently erased (e.g., erased concurrently as part of a single erase operation). Further, in some cases, NAND memory cells may be erased before they can be re-written with new data. Thus, for example, a used page 175 may, in some cases, not be updated until the entire block 170 that includes the page 175 has been erased.

In some cases, to update some data within a block 170 while retaining other data within the block 170, the memory device 130 may copy the data to be retained to a new block 170 and write the updated data to one or more remaining pages of the new block 170. The memory device 130 (e.g., the local controller 135) or the memory system controller 115 may mark or otherwise designate the data that remains in the old block 170 as invalid or obsolete and may update a logical-to-physical (L2P) mapping table to associate the logical address (e.g., LBA) for the data with the new, valid block 170 rather than the old, invalid block 170. In some cases, such copying and remapping may be performed instead of erasing and rewriting the entire old block 170 due to latency or wearout considerations, for example. In some cases, one or more copies of an L2P mapping table may be stored within the memory cells of the memory device 130 (e.g., within one or more blocks 170 or planes 165) for use (e.g., reference and updating) by the local controller 135 or memory system controller 115.

In some cases, L2P mapping tables may be maintained and data may be marked as valid or invalid at the page level of granularity, and a page 175 may contain valid data, invalid data, or no data. Invalid data may be data that is outdated, which may be due to a more recent or updated version of the data being stored in a different page 175 of the memory device 130. Invalid data may have been previously programmed to the invalid page 175 but may no longer be associated with a valid logical address, such as a logical address referenced by the host system 105. Valid data may be the most recent version of such data being stored on the memory device 130. A page 175 that includes no data may be a page 175 that has never been written to or that has been erased.

In some cases, a memory system controller 115 or a local controller 135 may perform operations (e.g., as part of one or more media management algorithms) for a memory device 130, such as wear leveling, background refresh, garbage collection, scrub, block scans, health monitoring, or others, or any combination thereof. For example, within a memory device 130, a block 170 may have some pages 175 containing valid data and some pages 175 containing invalid data. To avoid waiting for all of the pages 175 in the block 170 to have invalid data in order to erase and reuse the block 170, an algorithm referred to as “garbage collection” may be invoked to allow the block 170 to be erased and released as a free block for subsequent write operations. Garbage collection may refer to a set of media management operations that include, for example, selecting a block 170 that contains valid and invalid data, selecting pages 175 in the block that contain valid data, copying the valid data from the selected pages 175 to new locations (e.g., free pages 175 in another block 170), marking the data in the previously selected pages 175 as invalid, and erasing the selected block 170. As a result, the quantity of blocks 170 that have been erased may be increased such that more blocks 170 are available to store subsequent data (e.g., data subsequently received from the host system 105).

As described herein, the memory system 110 may obtain logical memory address validation information (e.g., SIT information) from the host system 105 in order to perform more reliable operations (e.g., more reliable garbage collection). In some examples, the memory system 110 (or memory system controller 115) may receive signaling from the host system 105 indicating a state (e.g., an invalid state or a valid state) of one or more logical memory addresses (e.g., SIT information). Using the signaling received from the host system 105, the memory system 110 (or memory system controller 115) may determine whether a state of a first logical memory address of the one or more logical memory addresses comprises the valid state or the invalid state. If the first logical memory address includes the valid state, the memory system 110 (or memory system controller 115) may adjust (e.g., increment) a counter (e.g., a VPC) allocated to a memory region corresponding to the first logical memory address and perform a garbage collection operation in accordance with a value of the counter. Using the methods as describe herein, the memory system 110 may obtain up-to-date information regarding the validity or invalidity of a logical memory addresses which may increase the reliability of operations performed by the memory system 110.

The system 100 may include any quantity of non-transitory computer readable media that support enhanced garbage collection at a memory system. For example, the host system 105 (e.g., a host system controller 106), the memory system 110 (e.g., a memory system controller 115), or a memory device 130 (e.g., a local controller 135), or any combination thereof may include or otherwise may access one or more non-transitory computer readable media storing instructions (e.g., firmware, logic, code) for performing the functions ascribed herein to the host system 105, the memory system 110, or the memory device 130, or combination thereof. For example, such instructions, if executed by the host system 105 (e.g., by a host system controller 106), by the memory system 110 (e.g., by a memory system controller 115), or by a memory device 130 (e.g., by a local controller 135), may cause the host system 105, the memory system 110, or the memory device 130 to perform associated functions as described herein.

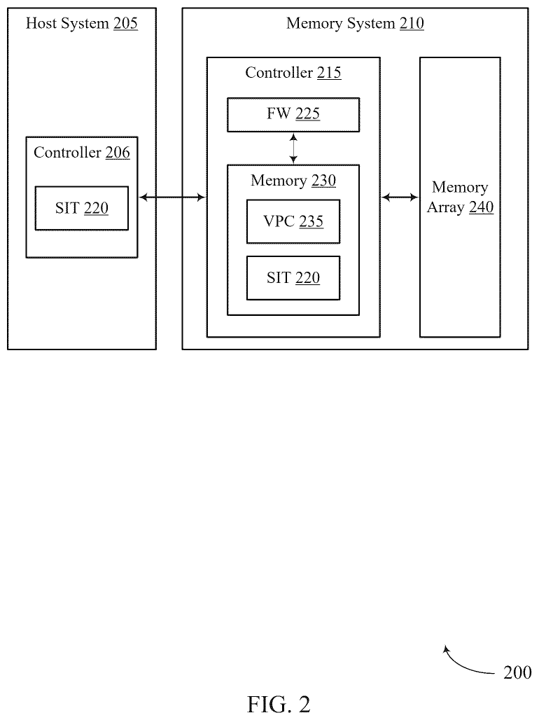

FIG. 2 shows an example of a system 200 that supports enhanced garbage collection at a memory system in accordance with examples as disclosed herein. In some examples, the system 200 may implement aspects of a system 100. For example, a host system 205, a memory system 210, a controller 206, a controller 215, and a memory array 240 may be an example of a host system 105, a memory system 110, a host system controller 106, a memory system controller 115, and a memory device 130 as described with reference to FIG. 1, respectively.

In some examples, the host system 205 may include a flash-friendly file system (F2FS) which may be an example of a log-structure file system (LFS). If a file needs modifying, the F2FS may allocate new logical memory addresses (e.g., logical block addresses (LBAs)) for write operations and invalidate old logical memory addresses. Further, the host system 205 may include a segment information table (SIT) to track a state (e.g., an invalid state or valid state) of the logical block addresses. For example, the SIT may include a bitmap, where each bit represents a state of a logical memory address. If the host system 205 invalids a logical memory address (e.g., as part of modifying a file), the host system 205 may update a logic state of a bit in the bitmap corresponding to the logical memory address to indicate an invalid state. In some examples, the host system 205 may store the SIT in memory of the controller 206.

In some examples, the memory system 210 may perform garbage collection. Garbage collection may be described as a type of memory management. During garbage collection, the memory system 210 may move valid data from a first physical memory location (e.g., a source block) within a memory array 240 of the memory system 210 to a second physical memory location (e.g., a target block) within the memory array 240. Once the valid data is moved, the memory system 210 may erase the data stored at the first physical memory location such that the first physical memory location may be utilized for subsequent write operations. In some examples, the memory system 210 may utilize valid page counters (VPCs) to identify the physical memory locations of the memory array 240 for garbage collection. A VPC may be an example of a counter whose value indicates a quantity of valid pages for a respective block of memory cells of the memory array 240. In some examples, the memory system 210 may select a block whose VPC value is less than other VPC values as a source block for garbage collection. In some examples, the memory system 210 may store the VPCs in memory 230 of the controller 215 or the memory array 240.

However, in some cases, the VPCs used by the memory system 210 during garbage collection may be stale. That is, the value of a VPC may not be accurate. Although the host system 205 may store and update the SIT 220 to keep track the state of the logical memory addresses, the memory system 210 may have no knowledge of the SIT. Instead, the host system 205 may transmit commands (e.g., unmap commands) indicating for the memory system 210 to release invalid logical memory addresses. But, during durations between these commands, the memory system 210 may perform garbage collection and as such, the VPC values used by the memory system 210 to perform the garbage collection may not accurately reflect the quantity of valid pages because the host system 205 may invalidate logical memory addresses during the durations and prior to garbage collection. As a result, the memory system 210 may perform garbage collection using stale VPCs.

As described herein, the host system 205 may exchange SIT information with the memory system 210 such that the memory system 210 may accurately and efficiently perform garbage collection. In some examples, the host system 205 may transmit signaling indicating the SIT 220 to the memory system 210 and the memory system 210 may store the SIT 220 in memory 230 of the controller 215 or the memory array 240. The memory system 210 may then update the SIT 220 using one or more techniques.

Using a first technique, the host system 205 may update the SIT 220 and transmit a command indicating a change in the SIT 220 to the memory system 210. For example, the host system 205 may specify a range of logical memory addresses of the SIT 220 whose states have changed from valid to invalid. Upon receiving the command, the memory system 210 may update the SIT 220 stored at the memory system 210 in accordance with the change indicated in the command.

Using a second technique, the host system 205 may update the SIT 220 thereby creating a second SIT 220 and transmit a command indicating the second SIT 220 to the memory system 210. Upon receiving the command, the memory system 210 may time stamp the second SIT 220 with a time (e.g., a time that the second SIT 220 arrives at the memory system 210) and compare the second SIT 220 with the SIT 220 stored at the memory system 210 (e.g., a SIT 220 associated with an earlier time stamp). If the memory system 210 determines a difference between the second SIT 220 and the SIT 220 stored at the memory system 210, the memory system 210 may then update the SIT 220 stored at the memory system 210 to match the second SIT 220.

In some examples, the command indicating the SIT information may be an example of an access command (e.g., a read command or a write command). Additionally, or alternatively, the command may include an extra header segment (EHS) that indicates the SIT information. Additionally, or alternatively, the command may be an example of a vendor unique command that is configured to carry the SIT information between the host system 205 and the memory system 210. In some examples, the host system 205 may transmit the command in response to the host system 205 detecting a change in the SIT (e.g., upon performing a file modified write or a file system garbage collection).

In some examples, the memory system 210 (or FW 225) may utilize the SIT 220 stored at the memory system 210 to build backup VPCs 235 (e.g., separate from the already stored VPCs). For example, the memory system 210 may analyze each LBA mapped to a physical memory address (e.g., physical page address (PPA)) of a valid region of the memory array 240 and determine, using the SIT 220, whether each of the LBAs includes a valid state or an invalid state. If an LBA is valid, the memory system 210 (or the FW 225) may adjust (e.g., increment, increase, change, modify) a backup VPC 235 corresponding to the valid memory region (e.g., by a value of one). Alternatively, if an LBA is not valid, the memory system 210 (or the FW 225) may not adjust (e.g., increment, increase, change, modify) the backup VPC 235 corresponding to the valid memory region. The memory system 210 may build a backup VPC 235 for each valid region of the memory system 210 (e.g., each valid block of the memory system 210). In some examples, the memory system 210 may build the backup VPCs 235 during a sleep mode or an idle mode. Further, in some examples, the memory system 210 may store the backup VPCs 235 in the memory 230 of the controller 215 or the memory array 240.

During garbage collection, the memory system 210 (or the FW 225) may utilize the backup VPCs 235. For example, the memory system 210 may select a block whose corresponding backup VPC value is smaller than one or more backup VPC values associated with other blocks as a source block for garbage collection. At a later time (e.g., succeeding the garbage collection), the memory system 210 may receive an unmap command from the host system 205 regarding the source block and in response to the unmap command, the memory system 210 may release the source block. Using the methods as described herein, the memory system 210 may have up-to-date knowledge of invalid logical block addresses which the memory system 210 may utilize to optimize garbage collection source block selection thereby increasing garbage collection efficiency and reliability.

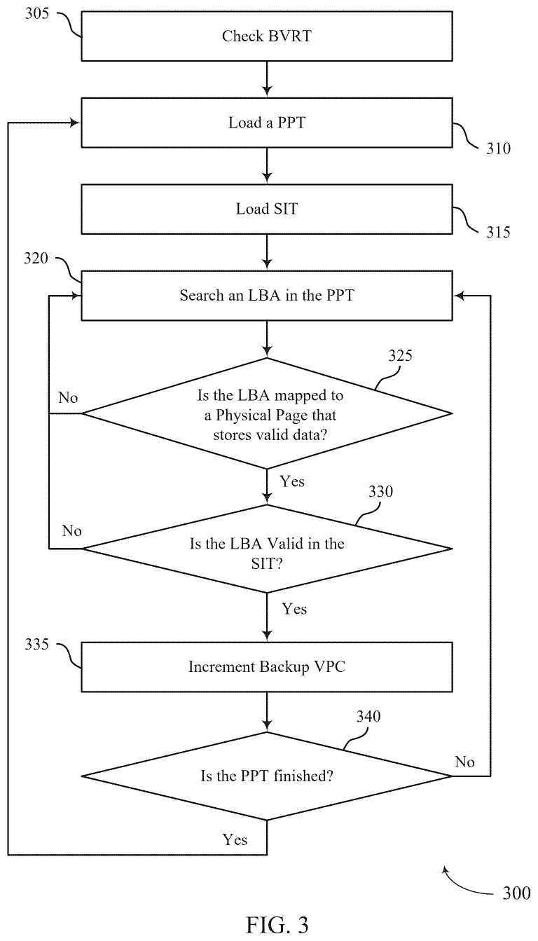

FIG. 3 shows an example of a flow diagram 300 that supports enhanced garbage collection at a memory system in accordance with examples as disclosed herein. In some examples, the flow diagram 300 may be implemented by aspects of the system 100 and the system 200. For example, steps of the flow diagram 300 may be performed by the memory system 210 or more specifically, the firmware (FW) 225 of the memory system 210 as described with reference to FIG. 2.

In some examples, prior to the start of the flow diagram 300, SIT information may be received. For example, the memory system may receive SIT information from the host system using one of the techniques described in FIG. 2. In some examples, the SIT information may include a structure of a SIT (e.g., a starting logical memory address, an ending logical memory address, a quantity of virtual blocks, a bitmap indicating the state of logical memory addresses, an age of the SIT, etc.). In another example, the SIT information may include an update to the SIT (e.g., a range of logical block addresses whose state changed from valid to invalid). In some examples, the memory system may store the SIT in memory of the memory system (e.g., main memory of the memory system or memory of a controller of the memory system). Further, prior to the start of the flow diagram 300, the memory system may enter a sleep mode or an idle mode. In some examples, the memory system may perform steps 305 to 340 while the memory system is in the idle mode or the sleep mode.

At 305, a block valid region (BVRT) table may be checked. For example, the memory system may check the BVRT. The BVRT may indicate whether one or more memory regions (e.g., blocks of memory cells or a 4 megabyte (MB) memory region of the memory system) stores valid data. The memory system may select a valid memory region from the BVRT and proceed to 310.

At 310, a physical page table (PPT) corresponding to the selected memory region may be loaded (e.g., obtained from main memory of the memory system and moved to memory of a controller of the memory system). For example, the memory system may load the PPT corresponding to the selected valid memory region. The PPT may indicate physical page addresses (PPAs) of pages included in the valid selected memory region. In some examples, each PPA of the PPT may be mapped to a respective logical memory address. Further, the PPT may indicate which pages of the valid memory region include valid data.

At 315, the SIT may be loaded (e.g., obtained from main memory of the memory system and moved to memory of a controller of the memory system). For example, the memory system may load the SIT. Upon loading the PPT and the SIT, the memory system may proceed to 320.

At 320, the PPT may be searched and an LBA may be identified in the PPT. For example, the memory system may search the PPT and identify an LBA corresponding to a PPA of the PPT. Once the memory system identifies the LBA, the memory system may proceed to 325.

At 325, it is determined whether a state of the LBA includes a valid state or invalid state using the PPT. For example, the memory system may utilize the PPT to determine whether the state of the LBA includes the valid state or the invalid state. The memory system may determine that the state of the LBA includes the valid state if the PPA corresponding to the LBA stores valid data (or is mapped to a source virtual block). The memory system may determine that the state of the LBA includes the invalid state if the PPA corresponding to the LBA stores invalid data (or is not mapped to a source virtual block). If the memory system determines that the states of the LBA includes the valid state, the memory system may proceed to 330. Alternatively, if the memory system determines that the state of LBA includes an invalid state, the memory system may proceed to 320 and search for a different LBA (e.g., a second LBA different from the LBA) in the PPT.

At 330, it is determined whether a state of the LBA includes a valid state or an invalid state using the SIT. For example, the memory system may utilize the SIT to determine whether the state LBA includes the valid of the invalid state. The memory system may determine that the state of the LBA include the valid state if a bit corresponding to the LBA in the SIT has a logic value that indicates the valid state. The memory system may determine that the state of the LBA include the invalid state if a bit corresponding to the LBA in the SIT has a logic value that indicates the invalid state. If the memory system determines that the states of the LBA includes the valid state, the memory system may proceed to 335. Alternatively, if the memory system determines that the state of LBA includes an invalid state, the memory system may proceed to 320 and search for a different LBA (e.g., a second logical memory address) in the PPT.

At 335, a backup VPC corresponding to the selected valid memory region may be incremented. For example, the memory system may adjust (e.g., increment, increase, change, modify) the VPC corresponding to the selected valid memory region by a value of 1. The value of the VPC may represent a quantity of valid pages included in the valid memory region. Once the memory system increments the VPC, the memory system may proceed to 340.

At 340, it is determined whether the PPT is finished. For example, the memory system may determine whether each of the LBAs in the PPT have been invalidated or validated via 325 and/or 330. If no, the memory system may proceed to 320 and search for a different LBA (e.g., a second LBA) in the PPT. If yes, the memory system may proceed to 310, and load a different PPT corresponding to the valid memory region. That is, the memory system may repeat one or more of steps 320 through 340 for each LBA in the PPT. Further, the memory system may repeat one or more of steps 310 through 340 for each PPT the valid memory region. The memory system may then store the backup VPC corresponding to the valid memory region in memory of the controller.

Further, the memory system may repeat one or more of steps 305 through 340 for each valid memory region of the BVRT. As such, the memory system may store multiple backup VPCs, each corresponding to a different valid memory region. Once the memory system has performed the steps 305 through 340 for all of the valid memory regions, the memory system may exit the flow diagram.

Using the backup VPCs, the memory system may perform garbage collection. For example, the memory system may select a memory region corresponding to a backup VPC whose value is less than other backup VPCs. Without the backup VPC, the memory system may utilize VPCs with stale information for garbage. Thus, the methods as described herein may enhance garbage collection at the memory system.

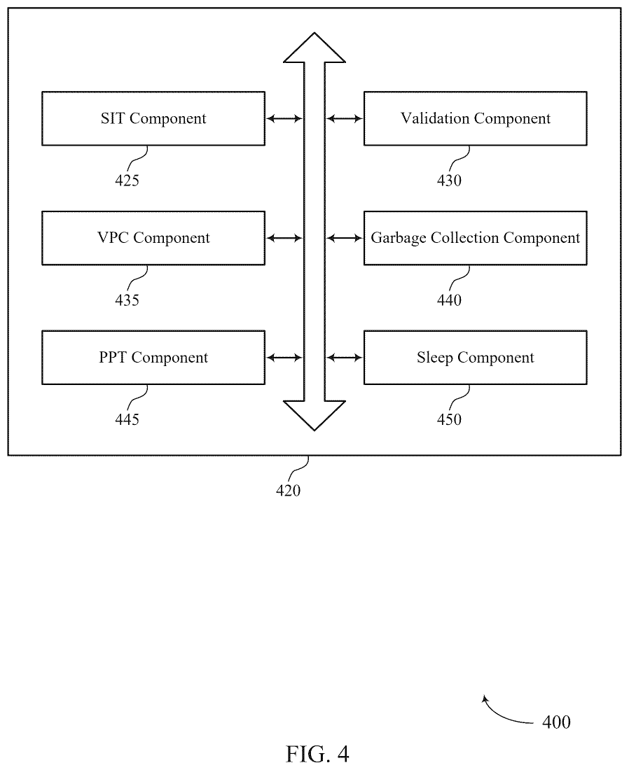

FIG. 4 shows a block diagram 400 of a memory system 420 that supports enhanced garbage collection at a memory system in accordance with examples as disclosed herein. The memory system 420 may be an example of aspects of a memory system as described with reference to FIGS. 1 through 3. The memory system 420, or various components thereof, may be an example of means for performing various aspects of enhanced garbage collection at a memory system as described herein. For example, the memory system 420 may include an SIT component 425, a validation component 430, a VPC component 435, a garbage collection component 440, a PPT component 445, a sleep component 450, or any combination thereof. Each of these components, or components of subcomponents thereof (e.g., one or more processors, one or more memories), may communicate, directly or indirectly, with one another (e.g., via one or more buses).

The SIT component 425 may be configured as or otherwise support a means for receiving signaling indicating a state of one or more logical memory addresses, the state including one of a valid state or an invalid state. The validation component 430 may be configured as or otherwise support a means for determining whether a state of a first logical memory address of the one or more logical memory addresses includes the valid state or the invalid state in response to the signaling. The VPC component 435 may be configured as or otherwise support a means for incrementing a counter allocated to a memory region corresponding to the first logical memory address in response to determining that the state of the first logical memory address includes the valid state. The garbage collection component 440 may be configured as or otherwise support a means for performing a garbage collection operation in accordance with a value of the counter.

In some examples, the PPT component 445 may be configured as or otherwise support a means for receiving second signaling indicating whether data stored at one or more physical memory addresses of the memory system includes valid data or invalid data.

In some examples, the validation component 430 may be configured as or otherwise support a means for determining whether valid data or invalid data is stored at a first physical memory address of the one or more physical memory addresses corresponding to the first logical memory address, where incrementing the counter is in response to determining that valid data is stored at the first physical memory address.

In some examples, to support receiving the signaling indicating the state of the one or more logical memory addresses, the SIT component 425 may be configured as or otherwise support a means for receiving a command including an extra header segment that indicates the state of the one or more logical memory addresses.

In some examples, the command includes a write command, a read command, or a garbage collection command.

In some examples, the SIT component 425 may be configured as or otherwise support a means for receiving, after receiving the signaling, second signaling indicating a second state of the one or more logical memory addresses, the second state including one of the valid state or the invalid state. In some examples, the SIT component 425 may be configured as or otherwise support a means for comparing the state of the one or more logical memory addresses to the second state of the one or more logical memory addresses in response to receiving the second signaling.

In some examples, to support receiving the signaling indicating the state of the one or more logical memory addresses, the SIT component 425 may be configured as or otherwise support a means for receiving a command that indicates the state of the one or more logical memory addresses.

In some examples, the sleep component 450 may be configured as or otherwise support a means for entering, prior to determining whether the state of the first logical memory address of the one or more logical memory addresses includes the valid state or the invalid state, a sleep mode, where incrementing the counter occurs while the memory system is in the sleep mode.

In some examples, the validation component 430 may be configured as or otherwise support a means for determining whether a state of a second logical memory address of the one or more logical memory addresses includes the valid state or the invalid state in response to the signaling. In some examples, the VPC component 435 may be configured as or otherwise support a means for incrementing a second counter allocated to a second memory region corresponding to the second logical memory address in response to determining that the state of the second logical memory address includes the valid state.

In some examples, to support performing the garbage collection operation, the garbage collection component 440 may be configured as or otherwise support a means for selecting the second memory region as a source of the garbage collection operation in response to a value of the second counter being smaller than a value of the counter.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

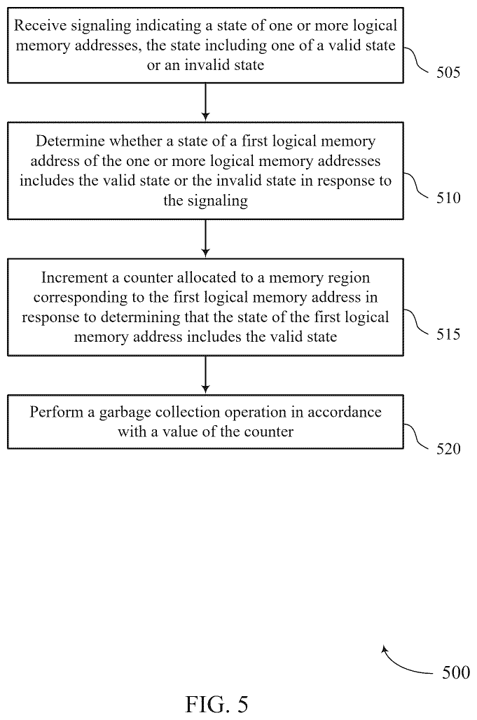

FIG. 5 shows a flowchart illustrating a method 500 that supports enhanced garbage collection at a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include receiving signaling indicating a state of one or more logical memory addresses, the state including one of a valid state or an invalid state. In some examples, aspects of the operations of 505 may be performed by an SIT component 425 as described with reference to FIG. 4.

At 510, the method may include determining whether a state of a first logical memory address of the one or more logical memory addresses includes the valid state or the invalid state in response to the signaling. In some examples, aspects of the operations of 510 may be performed by a validation component 430 as described with reference to FIG. 4.

At 515, the method may include adjusting (e.g., incrementing) a counter allocated to a memory region corresponding to the first logical memory address in response to determining that the state of the first logical memory address includes the valid state. In some examples, aspects of the operations of 515 may be performed by a VPC component 435 as described with reference to FIG. 4.

At 520, the method may include performing a garbage collection operation in accordance with a value of the counter. In some examples, aspects of the operations of 520 may be performed by a garbage collection component 440 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:

Aspect 1: A method, apparatus, or non-transitory computer-readable medium including operations, features, circuitry, logic, means, or instructions, or any combination thereof for receiving signaling indicating a state of one or more logical memory addresses, the state including one of a valid state or an invalid state; determining whether a state of a first logical memory address of the one or more logical memory addresses includes the valid state or the invalid state in response to the signaling; adjusting (e.g., incrementing) a counter allocated to a memory region corresponding to the first logical memory address in response to determining that the state of the first logical memory address includes the valid state; and performing a garbage collection operation in accordance with a value of the counter.

Aspect 2: The method, apparatus, or non-transitory computer-readable medium of aspect 1, further including operations, features, circuitry, logic, means, or instructions, or any combination thereof for receiving second signaling indicating whether data stored at one or more physical memory addresses of the memory system includes valid data or invalid data.

Aspect 3: The method, apparatus, or non-transitory computer-readable medium of aspect 2, further including operations, features, circuitry, logic, means, or instructions, or any combination thereof for determining whether valid data or invalid data is stored at a first physical memory address of the one or more physical memory addresses corresponding to the first logical memory address, where adjusting (e.g., incrementing) the counter is in response to determining that valid data is stored at the first physical memory address.

Aspect 4: The method, apparatus, or non-transitory computer-readable medium of any of aspects 1 through 3, where receiving the signaling indicating the state of the one or more logical memory addresses includes operations, features, circuitry, logic, means, or instructions, or any combination thereof for receiving a command including an extra header segment that indicates the state of the one or more logical memory addresses.

Aspect 5: The method, apparatus, or non-transitory computer-readable medium of aspect 4, where the command includes a write command, a read command, or a garbage collection command.

Aspect 6: The method, apparatus, or non-transitory computer-readable medium of any of aspects 1 through 5, further including operations, features, circuitry, logic, means, or instructions, or any combination thereof for receiving, after receiving the signaling, second signaling indicating a second state of the one or more logical memory addresses, the second state including one of the valid state or the invalid state and comparing the state of the one or more logical memory addresses to the second state of the one or more logical memory addresses in response to receiving the second signaling.

Aspect 7: The method, apparatus, or non-transitory computer-readable medium of any of aspects 1 through 6, where receiving the signaling indicating the state of the one or more logical memory addresses includes operations, features, circuitry, logic, means, or instructions, or any combination thereof for receiving a command that indicates the state of the one or more logical memory addresses.

Aspect 8: The method, apparatus, or non-transitory computer-readable medium of any of aspects 1 through 7, further including operations, features, circuitry, logic, means, or instructions, or any combination thereof for entering, prior to determining whether the state of the first logical memory address of the one or more logical memory addresses includes the valid state or the invalid state, a sleep mode, where adjusting (e.g., incrementing) the counter occurs while the memory system is in the sleep mode.

Aspect 9: The method, apparatus, or non-transitory computer-readable medium of any of aspects 1 through 8, further including operations, features, circuitry, logic, means, or instructions, or any combination thereof for determining whether a state of a second logical memory address of the one or more logical memory addresses includes the valid state or the invalid state in response to the signaling and adjusting (e.g., incrementing) a second counter allocated to a second memory region corresponding to the second logical memory address in response to determining that the state of the second logical memory address includes the valid state.

Aspect 10: The method, apparatus, or non-transitory computer-readable medium of aspect 9, where performing the garbage collection operation includes operations, features, circuitry, logic, means, or instructions, or any combination thereof for selecting the second memory region as a source of the garbage collection operation in response to a value of the second counter being smaller than a value of the counter.

It should be noted that the described techniques include possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (or in conductive contact with or connected with or coupled with) one another if there is any conductive path between the components that can, at any time, support the flow of signals between the components. At any given time, the conductive path between components that are in electronic communication with each other (or in conductive contact with or connected with or coupled with) may be an open circuit or a closed circuit in response to the operation of the device that includes the connected components. The conductive path between connected components may be a direct conductive path between the components or the conductive path between connected components may be an indirect conductive path that may include intermediate components, such as switches, transistors, or other components. In some examples, the flow of signals between the connected components may be interrupted for a time, for example, using one or more intermediate components such as switches or transistors.

The term “coupling” (e.g., “electrically coupling”) may refer to a condition of moving from an open-circuit relationship between components in which signals are not presently capable of being communicated between the components over a conductive path to a closed-circuit relationship between components in which signals are capable of being communicated between components over the conductive path. If a component, such as a controller, couples other components together, the component initiates a change that allows signals to flow between the other components over a conductive path that previously did not permit signals to flow.

The term “isolated” refers to a relationship between components in which signals are not presently capable of flowing between the components. Components are isolated from each other if there is an open circuit between them. For example, two components separated by a switch that is positioned between the components are isolated from each other if the switch is open. If a controller isolates two components, the controller affects a change that prevents signals from flowing between the components using a conductive path that previously permitted signals to flow.

The terms “if,” “when,” “based on,” or “based at least in part on” may be used interchangeably. In some examples, if the terms “if,” “when,” “based on,” or “based at least in part on” are used to describe a conditional action, a conditional process, or connection between portions of a process, the terms may be interchangeable.

The term “in response to” may refer to one condition or action occurring at least partially, if not fully, as a result of a previous condition or action. For example, a first condition or action may be performed, and a second condition or action may at least partially occur as a result of the previous condition or action occurring (whether directly after or after one or more other intermediate conditions or actions occurring after the first condition or action).

Additionally, the terms “directly in response to” or “in direct response to” may refer to one condition or action occurring as a direct result of a previous condition or action. In some examples, a first condition or action may be performed, and a second condition or action may occur directly as a result of the previous condition or action occurring independent of whether other conditions or actions occur. In some examples, a first condition or action may be performed, and a second condition or action may occur directly as a result of the previous condition or action occurring, such that no other intermediate conditions or actions occur between the earlier condition or action and the second condition or action or a limited quantity of one or more intermediate steps or actions occur between the earlier condition or action and the second condition or action. Any condition or action described herein as being performed “based on,” “based at least in part on,” or “in response to” some other step, action, event, or condition may additionally, or alternatively, (e.g., in an alternative example), be performed “in direct response to” or “directly in response to” such other condition or action unless otherwise specified.

The devices discussed herein, including a memory array, may be formed on a semiconductor substrate, such as silicon, germanium, silicon-germanium alloy, gallium arsenide, gallium nitride, etc. In some examples, the substrate is a semiconductor wafer. In some other examples, the substrate may be a silicon-on-insulator (SOI) substrate, such as silicon-on-glass (SOG) or silicon-on-sapphire (SOP), or epitaxial layers of semiconductor materials on another substrate. The conductivity of the substrate, or sub-regions of the substrate, may be controlled through doping using various chemical species including, but not limited to, phosphorus, boron, or arsenic. Doping may be performed during the initial formation or growth of the substrate, by ion-implantation, or by any other doping means.

A switching component or a transistor discussed herein may represent a field-effect transistor (FET) and comprise a three terminal device including a source, drain, and gate. The terminals may be connected to other electronic elements through conductive materials, e.g., metals. The source and drain may be conductive and may comprise a heavily-doped, e.g., degenerate, semiconductor region. The source and drain may be separated by a lightly-doped semiconductor region or channel. If the channel is n-type (i.e., majority carriers are electrons), then the FET may be referred to as an n-type FET. If the channel is p-type (i.e., majority carriers are holes), then the FET may be referred to as a p-type FET. The channel may be capped by an insulating gate oxide. The channel conductivity may be controlled by applying a voltage to the gate. For example, applying a positive voltage or negative voltage to an n-type FET or a p-type FET, respectively, may result in the channel becoming conductive. A transistor may be “on” or “activated” if a voltage greater than or equal to the transistor's threshold voltage is applied to the transistor gate. The transistor may be “off” or “deactivated” if a voltage less than the transistor's threshold voltage is applied to the transistor gate.

The description set forth herein, in connection with the appended drawings, describes example configurations and does not represent all the examples that may be implemented or that are within the scope of the claims. The term “exemplary” used herein means “serving as an example, instance, or illustration” and not “preferred” or “advantageous over other examples.” The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Further, various components of the same type may be distinguished by following the reference label by a hyphen and a second label that distinguishes among the similar components. If just the first reference label is used in the specification, the description is applicable to any one of the similar components having the same first reference label irrespective of the second reference label.

The functions described herein may be implemented in hardware, software executed by a processing system (e.g., one or more processors, one or more controllers, control circuitry, processing circuitry, logic circuitry), firmware, or any combination thereof. If implemented in software executed by a processing system, the functions may be stored on or transmitted over as one or more instructions (e.g., code) on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof designed to perform the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A memory system, comprising:
one or more memory devices; and
processing circuitry coupled with the one or more memory devices and configured to cause the memory system to:
receive signaling indicating a state of one or more logical memory addresses, the state comprising one of a valid state or an invalid state;
determine whether a state of a first logical memory address of the one or more logical memory addresses comprises the valid state or the invalid state in response to the signaling;
adjust a counter allocated to a memory region corresponding to the first logical memory address in response to determining that the state of the first logical memory address comprises the valid state; and
perform a garbage collection operation in accordance with a value of the counter.

2. The memory system of claim 1, wherein the processing circuitry is further configured to cause the memory system to:
receive second signaling indicating whether data stored at one or more physical memory addresses of the memory system comprises valid data or invalid data.

3. The memory system of claim 2, wherein the processing circuitry is further configured to cause the memory system to:
determine whether valid data or invalid data is stored at a first physical memory address of the one or more physical memory addresses corresponding to the first logical memory address, wherein adjusting the counter is in response to determining that valid data is stored at the first physical memory address.

4. The memory system of claim 1, wherein receiving the signaling indicating the state of the one or more logical memory addresses comprises the processing circuitry configured to cause the memory system to:
receive a command comprising an extra header segment that indicates the state of the one or more logical memory addresses.

5. The memory system of claim 4, wherein the command comprises a write command, a read command, or a garbage collection command.

6. The memory system of claim 1, wherein the processing circuitry is further configured to cause the memory system to:
receive, after receiving the signaling, second signaling indicating a second state of the one or more logical memory addresses, the second state comprising one of the valid state or the invalid state; and
compare the state of the one or more logical memory addresses to the second state of the one or more logical memory addresses in response to receiving the second signaling.

7. The memory system of claim 1, wherein receiving the signaling indicating the state of the one or more logical memory addresses comprises the processing circuitry configured to cause the memory system to:
receive a command that indicates the state of the one or more logical memory addresses.

8. The memory system of claim 1, wherein the processing circuitry is further configured to cause the memory system to:
enter, prior to determining whether the state of the first logical memory address of the one or more logical memory addresses comprises the valid state or the invalid state, a sleep mode, wherein adjusting the counter occurs while the memory system is in the sleep mode.

9. The memory system of claim 1, wherein the processing circuitry is further configured to cause the memory system to:
determine whether a state of a second logical memory address of the one or more logical memory addresses comprises the valid state or the invalid state in response to the signaling; and
adjust a second counter allocated to a second memory region corresponding to the second logical memory address in response to determining that the state of the second logical memory address comprises the valid state.

10. The memory system of claim 9, wherein performing the garbage collection operation comprises the processing circuitry configured to cause the memory system to:
select the second memory region as a source of the garbage collection operation in response to a value of the second counter being smaller than a value of the counter.

11. A non-transitory computer-readable medium storing code comprising instructions which, when executed by processing circuitry of a memory system, cause the memory system to:
receive signaling indicating a state of one or more logical memory addresses, the state comprising one of a valid state or an invalid state;
determine whether a state of a first logical memory address of the one or more logical memory addresses comprises the valid state or the invalid state in response to the signaling;
adjust a counter allocated to a memory region corresponding to the first logical memory address in response to determining that the state of the first logical memory address comprises the valid state; and
perform a garbage collection operation in accordance with a value of the counter.

12. The non-transitory computer-readable medium of claim 11, wherein the instructions, when executed by the processing circuitry of the memory system, further cause the memory system to:
receive second signaling indicating whether data stored at one or more physical memory addresses of the memory system comprises valid data or invalid data.

13. The non-transitory computer-readable medium of claim 12, wherein the instructions, when executed by the processing circuitry of the memory system, further cause the memory system to:
determine whether valid data or invalid data is stored at a first physical memory address of the one or more physical memory addresses corresponding to the first logical memory address, wherein adjusting the counter is in response to determining that valid data is stored at the first physical memory address.

14. The non-transitory computer-readable medium of claim 11, wherein the instructions to receive the signaling indicating the state of the one or more logical memory addresses, when executed by the processing circuitry of the memory system, cause the memory system to:
receive a command comprising an extra header segment that indicates the state of the one or more logical memory addresses.

15. The non-transitory computer-readable medium of claim 14, wherein the command comprises a write command, a read command, or a garbage collection command.

16. The non-transitory computer-readable medium of claim 11, wherein the instructions, when executed by the processing circuitry of the memory system, further cause the memory system to:
receive, after receiving the signaling, second signaling indicating a second state of the one or more logical memory addresses, the second state comprising one of the valid state or the invalid state; and
compare the state of the one or more logical memory addresses to the second state of the one or more logical memory addresses in response to receiving the second signaling.

17. The non-transitory computer-readable medium of claim 11, wherein the instructions to receive the signaling indicating the state of the one or more logical memory addresses, when executed by the processing circuitry of the memory system, cause the memory system to:
receive a command that indicates the state of the one or more logical memory addresses.

18. The non-transitory computer-readable medium of claim 11, wherein the instructions, when executed by the processing circuitry of the memory system, further cause the memory system to:
enter, prior to determining whether the state of the first logical memory address of the one or more logical memory addresses comprises the valid state or the invalid state, a sleep mode, wherein adjusting the counter occurs while the memory system is in the sleep mode.

19. The non-transitory computer-readable medium of claim 11, wherein the instructions, when executed by the processing circuitry of the memory system, further cause the memory system to:
determine whether a state of a second logical memory address of the one or more logical memory addresses comprises the valid state or the invalid state in response to the signaling; and
adjust a second counter allocated to a second memory region corresponding to the second logical memory address in response to determining that the state of the second logical memory address comprises the valid state.

20. The non-transitory computer-readable medium of claim 19, wherein the instructions to perform the garbage collection operation, when executed by the processing circuitry of the memory system, cause the memory system to:
select the second memory region as a source of the garbage collection operation in response to a value of the second counter being smaller than a value of the counter.

21. A method by a memory system, comprising:
receiving signaling indicating a state of one or more logical memory addresses, the state comprising one of a valid state or an invalid state;
determining whether a state of a first logical memory address of the one or more logical memory addresses comprises the valid state or the invalid state in response to the signaling;
adjusting a counter allocated to a memory region corresponding to the first logical memory address in response to determining that the state of the first logical memory address comprises the valid state; and
performing a garbage collection operation in accordance with a value of the counter.

22. The method of claim 21, further comprising:
receiving second signaling indicating whether data stored at one or more physical memory addresses of the memory system comprises valid data or invalid data.
